(19) United States
(12) Patent Application Publication
(10) Pub. No.: US 2011/0217220 A1
(43) Pub. Date: Sep. 8, 2011

(54) Metal Oxide Compositions for Sequestering Carbon Dioxide and Methods of Making and Using the Same

(75) Inventors: Joseph M. McLellan, Quincy, MA (US); Xinhua Li, Newton, MA (US); Graciela Beatriz Blanchet, Boston, MA (US); David Picard, Jamaica Plains, MA (US)

(73) Assignee: Nano Terra Inc., Cambridge, MA (US)

(21) Appl. No.: 12/878,277

(22) Filed: Sep. 9, 2010

Related U.S. Application Data
(60) Provisional application No. 61/240,891, filed on Sep. 9, 2009.
(60) Provisional application No. 61/294,411, filed on Jan. 12, 2010.

(51) Int. Cl. B01D 53/62; B29C 47/00

(52) U.S. Cl. 423/230; 428/401; 264/484

(57) ABSTRACT

The present invention is directed to methods of sequestering carbon dioxide using metal oxide compositions, methods of making the metal oxide compositions, and articles comprising the metal oxide compositions.

### CROSS-REFERENCE TO RELATED APPLICATIONS

This application claims the benefit of the filing date of U.S. Provisional Appl. No. 61/240,891, filed Sep. 9, 2009, and U.S. Provisional Appl. No. 61/294,411, filed Jan. 12, 2010, both of which are incorporated herein by reference in the entirety.

### BACKGROUND OF THE INVENTION

1. Field of the Invention

The present invention is directed to metal oxide compositions having a high surface area-to-volume ratio. The present invention is directed to methods of making the metal oxide compositions, articles comprising the metal oxide compositions and methods of using the metal oxide compositions to sequester carbon dioxide.

2. Background

Industrialization has resulted in a steady increase in atmospheric carbon dioxide levels, which some evidence suggests is leading to increased terrestrial surface temperatures. The removal and sequestration of existing atmospheric carbon dioxide, which presently is at a level of about 390 ppm, has been proposed one possible means for countering this problem. Another approach for addressing the problem of increasing atmospheric levels of carbon dioxide is to sequester newly formed carbon dioxide at its source. In addition to preventing further increases in atmospheric carbon dioxide, the latter approach is attractive because removing carbon dioxide from an exhaust or waste stream, in which carbon dioxide concentrations are potentially high, may be more efficient than sequestering carbon dioxide from the atmosphere. However, few low cost materials have been identified that are capable of efficiently reacting with carbon dioxide under mild conditions.

Underwater breathing apparatuses (UBAs) also rely on CO₂ removal (“scrubbers”) to ensure the personnel safety when using manned submersibles and other undersea platforms. However, scrubber technology has not evolved significantly in 50 years, and is based on millimeter-size granules or hard tablets that contain calcium hydroxide (Ca(OH)₂) and small amounts of sodium hydroxide (NaOH) and potassium hydroxide (KOH), with an optional color indicator to show when the material is saturated with CO₂. Similar technology is also used to remove CO₂ from analytic instrumentation (e.g., from the sample chamber of infrared spectrophotometers), in medical applications to remove CO₂ from anesthetic delivery systems, and in a variety of other commercial chemical applications. However, current scrubber technology is heavy and cumbersome, exhibits decreased performance at low temperatures (such as those experienced at significant depths), and can react with moisture to result in drastically decreased performance.

### BRIEF SUMMARY OF THE INVENTION

What is needed is a low-cost composition that can react readily with carbon dioxide under a wide range of conditions to provide a highly stable chemical product.

The present invention is directed to a method for sequestering carbon dioxide, the method comprising contacting a composition comprising carbon dioxide with a metal oxide composition, wherein the metal oxide composition has an average cross-sectional dimension of 10 nm to 10 μm, wherein the metal oxide composition has an average metal oxide grain size of 50 nm or less; and reacting the carbon dioxide with at least a portion of the metal oxide composition to form a metal carbonate.

The present invention is also directed to a method for sequestering carbon dioxide, the method comprising contacting a composition comprising carbon dioxide with a metal oxide composition, wherein the metal oxide composition comprises a plurality of elongated structures having an average length of 1 cm or more and an average cross-sectional dimension of 500 μm or less; and reacting the carbon dioxide with at least a portion of the metal oxide composition to form a metal carbonate. In some embodiments, the metal oxide composition comprises a plurality of elongated structures having an average cross-sectional dimension of 10 nm to 100 μm, 50 nm to 50 μm, or 100 nm to 10 μm.

In some embodiments, the metal oxide is selected from: MgO, Mg(OH)₂, Mg₂SiO₄, Mg₃Si₂O₅(OH)₄, Na₂O, K₂O, CaO, Ca(OH)₂, FeO, Fe₂O₃, and combinations thereof.

The present invention is also directed to a composition comprising a metal oxide selected from: MgO, Mg(OH)₂, Mg₂SiO₄, Mg₃Si₂O₅(OH)₄, Na₂O, K₂O, CaO, Ca(OH)₂, FeO, Fe₂O₃, and combinations thereof, wherein the metal oxide is present as a plurality of elongated structures having an average cross-sectional dimension of 500 μm or less.

The present invention is also directed to a method of making a metal oxide composition, the method comprising:
(a) electrospinning a plurality of metal compound-polymer wires by:
   (i) flowing a solution comprising a metal compound and a polymer through a biased needle to provide a plurality of metal compound-polymer wires; and
   (ii) collecting the metal compound-polymer wires with a biased collector; and
(b) heating the metal compound-polymer wires in an oxidizing atmosphere at a temperature sufficient and for a time sufficient to convert the metal compound to a metal oxide, wherein the metal oxide wires have an average cross-sectional dimension of 500 μm or less.

In some embodiments, the metal compound is selected from: Mg(NO₃)₂, Ca(NO₃)₂, Mg(CH₃CO₂)₂, Ca(CH₃CO₂)₂, CaCl₂, MgCl₂, Na(CH₃CO₂), K(CH₃CO₂), hydrates thereof, and combinations thereof.

In some embodiments, the metal oxide composition is a metal hydroxide. In some embodiments, the method comprises contacting a composition comprising carbon dioxide with the metal hydroxide; and reacting the carbon dioxide with at least a portion of the metal hydroxide to form a metal bicarbonate.

In some embodiments, the heating comprises a temperature of 100° C. to 1000° C. In some embodiments, the heating comprises a time of 1 minute to 48 hours.

In some embodiments, a method comprises mechanically converting the metal oxide wires to provide a powder.

In some embodiments, a method comprises bonding metal oxide wires or a precursor thereof to provide a monolithic structure. In some embodiments, bonding comprises, before the heating, exposing the metal compound-polymer wires to water vapor.

In some embodiments, a method comprises affixing the metal oxide composition to a support material.

In some embodiments, the metal oxide composition comprises a plurality of elongated structures having an average cross-sectional dimension of 10 nm to 100 μm, 50 nm to 50 μm, or 100 nm to 10 μm, 200 nm to 1 μm, or 200 nm to 500 nm.

In some embodiments, the metal oxide composition comprises a plurality of elongated structures having an average length of 1 cm or more.

In some embodiments, the metal oxide composition has an average metal oxide grain size of 50 nm or less, or 10 nm or less.

In some embodiments, the metal oxide composition has an interstitial porosity of 20% or greater. In some embodiments, the metal oxide composition has an average interstitial pore size of 10 nm to 10 μm.

In some embodiments, the metal oxide composition has a surface area of 5 m²/g or greater. In some embodiments, the metal oxide composition has a surface area of 15 m²/cm³ or greater.

In some embodiments, the reacting of the metal oxide composition with carbon dioxide is performed at a temperature of 200° C. or lower. In some embodiments, the reacting of the metal oxide composition with carbon dioxide is performed at a pressure of 2 atm or lower. In some embodiments, the reacting of the metal oxide composition with carbon dioxide is performed at a temperature of 100° C. lower less and a pressure of 1.5 atm or lower.

In some embodiments, the metal oxide composition undergoes a gain in mass of at least 10% as a result of reacting of the metal oxide composition with carbon dioxide.

In some embodiments, a composition comprising carbon dioxide is selected from: a gaseous composition, a liquid composition, a solid composition, and combinations thereof. In some embodiments, before the contacting and the reacting, carbon dioxide is present in a composition in a molar concentration of 400 ppm to 99% of the composition. In some embodiments, the reacting a composition comprising carbon dioxide reduces a molar concentration of carbon dioxide in the composition by 10% or greater.

The present invention is also directed to an article of manufacture comprising the metal oxide composition of the present invention. In some embodiments, a metal oxide composition is present in an article of manufacture as a non-woven mat. In some embodiments, an article of manufacture is a flow-through device, and the metal oxide composition is present as a packing material in the flow-through device. In some embodiments, a metal oxide composition is present in an article of manufacture as a monolith.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A, 1B, 1C and 1D provide scanning electron microscope (SEM) images of elongated metal oxide compositions of the present invention.

FIGS. 2A, 2B and 2C provide SEM images of a bonded metal oxide composition of the present invention.

FIG. 3 provides a graphic representation of the percentage change in mass versus time after various metal oxide compositions were exposed to a stream of CO₂.

FIGS. 4A-4C provide SEM images of a metal oxide nanofiber composition (FIG. 4A) of the present invention, and comparative metal oxide powder compositions (FIGS. 4B-4C).

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “some embodiments,” “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

As used herein, “at least one” refers to one or more. As used herein, “a plurality” refers to two or more.

References to spatial descriptions (e.g., “above,” “below,” “up,” “down,” “top,” “bottom,” etc.) made herein are for purposes of description and illustration only, and should be interpreted as non-limiting upon the metal oxide compositions, methods, and products of any method of the present invention, which can be spatially arranged in any orientation or manner.

### Metal Oxide Compositions

The present invention refers to metal oxide compositions, methods to prepare the metal oxide compositions, and methods of using the metal oxide compositions for sequestering carbon dioxide. As used herein, a “metal oxide” refers to a Group IA, IIA, IIIB and/or transition metal that forms a bond with oxygen having a −2 oxidation state (i.e., O²⁻). As used herein, a “metal oxide” includes metal oxides, metal hydroxides (i.e., M^{x+}(OH)ₓ, where M is a metal and x is an integer from 1 to 6), partial hydroxides, and the like, and mixtures, and hydrates thereof.

The compositions of the present invention provide many advantages for gas absorption. First, the dimensions and elongated shape of the compositions provides much higher active surface area for reaction with CO₂ compared to the currently available soda lime sorbents that have dimensions on the millimeter scale. The compositions also can have an open porous network that provides low resistance to flow and enables the efficient utilization of the material.

Representative metals for use with the present invention include, but are not limited to, lithium, sodium, magnesium, calcium, titanium, iron, nickel, copper, zinc, aluminum, and the like, and combinations thereof. In some embodiments, a metal oxide is selected from: MgO, Mg(OH)₂, Mg₂SiO₄, Mg₃Si₂O₅(OH)₄, Na₂O, K₂O, CaO, Ca(OH)₂, and the like, and combinations thereof. In some embodiments, a metal oxide includes an “airon metal” oxide (i.e., a metal oxide that forms spontaneously upon contact with air) such as, but not limited to, FeO, Fe₂O₃, and the like, and combinations thereof.

In some embodiments, an elongated structure comprises a first metal oxide and a second metal oxide, in which the first and second metal oxides are present as separate grains within the composition, form a core-shell structure (either as a core-shell on the level of the elongated structure and/or on the level of individual grains), form an alloy (e.g., an alloy of calcium and magnesium oxide), and the like, and combinations thereof.

The metal oxide compositions of the present invention have a high surface area-to-mass and/or high surface area-to-volume ratio. For example, in some embodiments a metal oxide composition of the present invention has a surface area of 5 m²/g or greater, 10 m²/g or greater, 20 m²/g or greater, 30 m²/g or greater, 40 m²/g or greater, 50 m²/g or greater, 75 m²/g or greater, or 100 m²/g or greater. In some embodiments a metal oxide composition of the present invention has a surface area of 5 m²/g to 50 m²/g, 5 m²/g to 25 m²/g, 5 m²/g to 10 m²/g, 10 m²/g to 50 m²/g, 10 m²/g to 30 m²/g, 10 m²/g to 20 m²/g, 25 m²/g to 50 m²/g, or 30 m²/g to 50 m²/g.

In some embodiments, a metal oxide composition of the present invention has a surface area of 15 m²/cm³ or greater, 20 m²/cm³ or greater, 25 m²/cm³ or greater, 50 m²/cm³ or greater, 75 m²/cm³ or greater, 100 m²/cm³ or greater, 150 m²/cm³ or greater, or 200 m²/cm³ or greater. In some embodiments a metal oxide composition of the present invention has a surface area of 15 m²/cm³ to 200 m²/cm³, 15 m²/cm³ to 150 m²/cm³, 15 m²/cm³ to 1 m²/cm³, 25 m²/cm³ to 200 m²/cm³, 25 m²/cm³ to 150 m²/cm³, 25 m²/cm³ to 1 m²/cm³, 50 m²/cm³ to 200 m²/cm³, 50 m²/cm³ to 150 m²/cm³, 50 m²/cm³ to 100 m²/cm³, 75 m²/cm³ to 200 m²/cm³, 75 m²/cm³ to 150 m²/cm³, 75 m²/cm³ to 125 m²/cm³, 100 m²/cm³ to 200 m²/cm³, or 100 m²/cm³ to 150 m²/cm³.

In some embodiments, the metal oxide compositions of the present invention are present as an elongated structure. As used herein, an “elongated structure” refers to a three-dimensional shape having at least one primary axis (e.g., a length) that is greater in magnitude than another axis or dimension of the structure (e.g., a width, height, diameter, and the like). Elongated structures include, but are not limited to, wires, tubes, rods, ribbons, fibers, platelets, hairs, and the like. In some embodiments, the elongated structures are nanowires, nanotubes, nanorods, nanoribbons, nanofibers, and the like, which have an average cross-sectional dimension of 100 nm or less. The wires, tubes, rods, ribbons, fibers, platelets, hairs, and the like, of the present invention can also have a cross-sectional dimensional on the sub-micron (i.e., <1 μm) or micron (>1 μm) scale.

As used herein, “wire” refers to an elongated structure that includes at least one cross sectional dimension of 10 nm to 500 μm, 10 nm to 100 μm, 10 nm to 50 μm, 10 nm to 10 μm, 10 nm to 5 μm, 10 nm to 2 μm, 10 nm to 1 μm, 100 nm to 500 nm, 1 μm or less, 500 nm or less, 100 nm or less, or 50 nm or less, and has an aspect ratio (length:width) of 10 or more, 50 or more, 100 or more, or 1,000 or more.

In some embodiments, a wire has a circular cross-section (i.e., the wire has a cylindrical three-dimensional shape). Further cross-sectional shapes for an elongated structure of the present invention include, but are not limited to, an ellipsoidal cross-section, a triangular cross-section, a rectilinear cross-section (e.g., a square, rectangular, and/or four-sided polygonal cross-section), a pentagonal cross-section, a hexagonal cross-section, an octagonal cross-section, a star-shaped cross-section (e.g., four-, five-, and/or six-pointed star shapes), and the like, and combinations thereof.

As used herein, the term “wire” is interchangeable with the terms “rod,” “tube,” “ribbon,” “fiber,” and the like, and combinations thereof. Thus, wires for use with the present invention are not limited to objects having a tubular or cylindrical shape, but can also include tubes and/or cylinders having a circular, ellipsoidal or irregular cross section, as well as cones, rods, ribbons, and the like.

As used herein, the term “nanotube” and “tube” refer to a cylindrical structure having a porous, hollow, filled, or partially filled tube-portion, the former having an average cross-sectional dimension ≦100 nm.

As used herein, the term “nanoribbon” and “ribbon” refer to a flat, laminar, curled, helical and/or spiral elongated structure, the former having an average cross-sectional dimension ≦100 nm.

As used herein, the term “nanorod” and “rod” refer to any elongated structure, and is similar to a wire, but having an aspect ratio (length:cross-sectional dimension) less than that of a wire, the former having an average cross-sectional dimension ≦100 nm.

As used herein, the term “fiber” refers to an elongated structure, and is similar to a wire, but having an aspect ration (length:cross-sectional dimension) greater than that of a wire. In some embodiments, a fiber has a length of 10 mm to 1 m, 10 mm to 500 mm, 10 mm to 100 mm, or 10 mm to 50 mm.

As used herein, an “aspect ratio” is the length of a first axis of a structure divided by the average of the lengths of second and third axes of the structure, where the second and third axes are two axes whose lengths are most nearly equal to each other. For example, the aspect ratio for a perfect rod is the length of its long axis divided by the diameter of a cross-section perpendicular to (normal to) the long axis.

In some embodiments, a metal oxide composition of the present invention comprises a plurality of elongated structures having a rod, platelet, wire, or ribbon shape. In some embodiments, a metal oxide composition comprises a plurality of elongated structure having an average length of 1 cm or more, 5 cm or more, 10 cm or more, 50 cm or more, or 1 m or more. In some embodiments, a metal oxide composition comprises a plurality of elongated structure having an average length of 1 cm to 5 m, 1 cm to 1 m, cm to 100 cm, 10 cm to 50 cm, 1 cm, 2 cm, 5 cm, 10 cm, 50 cm, or 1 m.

In some embodiments, a metal oxide composition of the present invention comprises a plurality of elongated structures having an average cross-sectional dimension (e.g., an average diameter) of 10 nm to 500 μm, 10 nm to 100 μm, 10 nm to 50 μm, 10 nm to 10 μm, 10 nm to 5 μm, 10 nm to 1 μm, 10 nm to 500 nm, 10 nm to 250 nm, nm to 100 nm, 10 nm to 50 nm, 50 nm to 100 μm, 50 nm to 50 μm, 50 nm to 10 μm, 50 nm to 5 μm, 50 nm to 2 μm, 50 nm to 1 μm, 50 nm to 750 nm, 50 nm to 500 nm, 50 nm to 250 nm, 50 nm to 100 nm, 100 nm to 10 μm, 100 nm to 1 μm, 100 nm to 750 nm, 100 nm to 500 nm, 100 nm to 400 nm, 100 nm to 300 nm, 100 nm to 250 nm, 100 nm to 200 nm, 200 nm to 5 μm, 200 nm to 1 μm, 200 nm to 750 nm, 200 nm to 500 nm, 200 nm to 400 nm, 300 nm to 500 nm, 500 nm to 10 μm, 1 μm to 10 μm, 2 μm to 10 μm, about 50 nm, about 100 nm, about 200 nm, about 300 nm, about 400 nm, about 500 nm, about 1 μm, about 2 μm, about 5 μm, or about 10 μm.

Typically, a metal oxide composition of the present invention comprises void space or porosity. As used herein, “porous” and “porosity” are interchangeable and can refer either to void space (i.e., pores) present between adjacent metal oxide structures (i.e., interstitial pores) or to void space (i.e., pores) present within a single metal oxide structure (i.e., intrastitial pores). Pore size and porosity can be determined by analytical methods known to persons of ordinary skill in the art, including, but not limited to, theoretical modeling, optical methods, chemical gas adsorption methods, physical gas adsorption methods, mercury intrusion porosimetry methods, positronium annihilation lifetime scattering (PALS), and the like, and combinations thereof.

In some embodiments, a metal oxide composition of the present invention has an interstitial porosity of 20% or greater, 30% or greater, 40% or greater, 50% or greater, 60% or greater, 70% or greater, 80% or greater, or 90% or greater.

In some embodiments, a metal oxide composition of the present invention comprises interstitial pores having an average size of 10 nm to 10 μm, 10 nm to 5 μm, 10 nm to 2 μm, 10 nm to 1 μm, 10 nm to 750 nm, 10 nm to 500 nm, or 10 nm to 250 nm.

In some embodiments, a metal oxide composition of the present invention comprises interstitial pores having an average pore size of 10 μm or less, wherein not more than 10% of the interstitial pores are larger than 50 μm.

In some embodiments, a metal oxide composition of the present invention comprises a plurality of elongated structures or products prepared there from having an intrastitial porosity of 1% or greater, 5% or greater, 10% or greater, 20% or greater, 30% or greater, 40% or greater, 50% or greater, 60% or greater, or 70% or greater. In some embodiments, a metal oxide composition of the present invention has an intrastitial porosity of 1% to 65%, 5% to 60%, 10% to 50%, 15% to 40%, or 20% to 30% by volume. For example, a metal oxide composition of the present invention comprises a plurality of structures having hollow cores, or at least a portion of an elongated structure comprises interconnected pores that form a channel, or an elongated structure comprises a plurality of individual grains having void space there between, or combinations thereof.

In some embodiments, a metal oxide composition of the present invention comprises a plurality of metal oxide grains. In some embodiments, a metal oxide composition has an average metal oxide grain size of 50 nm or less, 40 nm or less, 30 nm or less, 20 nm or less, 10 nm or less, or 5 nm or less. In some embodiments, a metal oxide composition has an average metal oxide grain size of 5 nm to 50 nm, 5 nm to 40 nm, 5 nm to 30 nm, 5 nm to 20 nm, 10 nm to 50 nm, 10 nm to 40 nm, 10 nm to 30 nm, 10 nm to 20 nm, 20 nm to 50 nm, about 5 nm, about 10 nm, about 15 nm, about 20 nm, about 25 nm, about 30 nm, about 40 nm, or about 50 nm.

In some embodiments, a metal oxide composition of the present invention includes a plurality of elongated structures having a predominant shape such as, for example, a wire, fiber, or ribbon shape. In some embodiments, a metal oxide composition of the present invention includes a mixture of shapes. Different shapes within a metal oxide composition can comprise the same or different metal oxides (e.g., a plurality of structures having the same shape, but different composition; a plurality of structures having a consistent composition, but different shapes; or a plurality of structures having diverse shapes and compositions).

The metal oxide compositions of the present invention can be flexible. In some embodiments, an individual metal oxide structure is substantially rigid at the scale of tens or hundreds of nanometers, but can be flexed along its long axis without breaking Thus, in some embodiments a metal oxide composition of the present invention can be shaped or molded to either a flat or curved shape, or a combination thereof.

In some embodiments, a metal oxide compositions of the present invention comprises a plurality of structures having a Young's Modulus of 1 GPa to 1,000 GPa, 10 GPa to 1,000 GPa, 50 GPa to 1,000 GPa, 100 GPa to 1,000 GPa, or 500 GPa to 1,000 GPa. In some embodiments, the Young's Modulus of a metal oxide structure of the present invention is substantially the same as the Young's Modulus a bulk material having the same composition as the structure.

### Articles

The present invention is also directed to articles comprising a metal oxide composition of the present invention.

In some embodiments, an article comprises a plurality of elongated structures as a non-woven mat. A non-woven mat can have a thickness of 10 μm to 10 m. Thus, a mat can be used as a packing material in an exhaust, a smokestack, a filter for use in a recirculating air system, and the like.

In some embodiments, an article is provided as a flow-through device comprising the metal oxide composition as a rechargeable packing material. For example, flow-through devices include columns, scrubbers, filters, converters, piping, and any other system having an inlet and an outlet. In some embodiments, a flow-through device of the present invention is suitable for attachment to at least a portion of an exhaust of an internal combustion engine, an exhaust of a jet engine, an automobile exhaust, a truck exhaust, a motorcycle exhaust, a reactor exhaust, a jet exhaust, a smokestack, a chimney, a kitchen exhaust, a heater exhaust, and the like.

A flow-through device can include the metal oxide composition of the present invention as a packing material such as, but not limited to, a plurality of elongated structures, a mat, a non-woven mat, a particulate, a powder, a membrane, a wool, and the like, and combinations thereof.

In some embodiments, a plurality of elongated metal oxide structures are at least partially fused to provide a monolithic article, for example, a sheet, a membrane, a sponge, and the like.

In some embodiments, an article of the present invention comprises metal oxide structures in a concentration of 0.5% to 80%, 0.5% to 60%, 0.5% to 50%, 0.5% to 25%, 0.5% to 15%, 0.5% to 10%, 0.5% to 5%, 1% to 50%, 1% to 25%, 1% to 10%, 5% to 80%, 5% to 60%, 5% to 50%, 5% to 40%, 5% to 30%, 5% to 25%, 10% to 80%, 10% to 50%, 10% to 25%, 15% to 80%, 15% to 50%, 15% to 40%, 20% to 80%, 20% to 60%, 20% to 50%, 25% to 75%, 25% to 50%, 30% to 80%, 30% to 60%, 40% to 80%, about 0.5%, about 1%, about 2%, about 3%, about 4%, about 5%, about 7.5%, about 10%, about 12.5%, about 15%, about 20%, about 25%, about 30%, about 40%, about 50%, about 60%, about 70%, or about 80% by volume.

In some embodiments, an article of the present invention comprises a component selected from: a filler, a scaffold, a support, a chemical stabilizer, an antioxidant, and the like, and combinations thereof.

Not being bound by any particular theory, a filler, scaffold, support, and the like can function as a dimensional stabilizer in an article of the present invention, for example, to provide enhanced dimensional stability during shipment and/or use, and/or to prevent agglomeration, sedimentation, and/or reaction of the metal oxide composition prior to use.

Support, scaffold and/or filler materials suitable for use with the present invention include, but are not limited to, a metal, a metal oxide, a ceramic, a glass, a polymer, wood, stone, cement, and the like, particulates thereof, fibers thereof, laminates thereof, and combinations thereof.

### Methods of Making the Metal Oxide Compositions

The present invention is also directed to a method of making a metal oxide composition, the method comprising:
(a) electrospinning a plurality of metal compound-polymer wires by:
   (i) flowing a solution comprising a metal compound and a polymer through a biased needle to provide a plurality of metal compound-polymer wires; and
   (ii) collecting the metal compound-polymer wires with a biased collector; and
(b) heating the metal compound-polymer wires at a temperature sufficient and for a time sufficient to convert the metal compound to a metal oxide, wherein the metal oxide wires have an average cross-sectional dimension of 500 μm or less.

In some embodiments, the metal compound is selected from: Mg(NO₃)₂, Ca(NO₃)₂, Mg(CH₃CO₂)₂, Ca(CH₃CO₂)₂, CaCl₂, MgCl₂, Na(CH₃CO₂), K(CH₃CO₂), a hydrate thereof, and combinations thereof.

In some embodiments, a metal compound is present in a solution for use with an electrospinning process of the present invention in a concentration of 0.1 M to 5 M, 0.1 M to 2.5 M, 0.1 M to 2 M, 0.1 M to 1.5 M, 0.1 M to 1 M, 0.5 M to 5 M, 0.5 M to 2.5 M, 0.5 M to 2 M, 0.5 M to 1.5 M, 0.5 M to 1 M, 1 M to 5 M, 1 M to 2.5 M, 1 M to 2 M, 1 M to 1.5 M, about 0.5 M, about 1 M, about 1.5 M, or about 2 M.

The solutions for use with the present invention comprise a solvent. Solvents suitable for use with the electrospinning process of the present invention include, but are not limited to, water, an alcohol (e.g., methanol, ethanol, propanol, butanol, pentanol, hexanol, and the like), a glycol (e.g., ethylene glycol, propylene glycol, diethylene glycol, tetraethylene glycol, and the like, and esters thereof), a glycol ether (e.g., ethylene glycol dimethylether, ethylene glycol diethylether, and the like), an amide (e.g., dimethylformamide, diethylformamide, dimethylacetamide, and the like), N-methylpyrrolidone (NMP), a ketone (e.g., acetone, methylethylketone, butanone, and the like), an ester (e.g., ethylacetate, and the like), an ether (e.g., dimethylether, dipropylether, and the like), a chlorinated solvent (e.g., methylenechloride, chloroform, 1,2-dichloroethane, and the like), aromatic solvents (e.g., benzene, chlorobenzene, furan, pyridine, quinoline, and the like), and combinations thereof. In some embodiments, a solvent comprises an aqueous mixture of water and one or more organic solvents that is miscible with water.

The solvent for use with the electrospinning process can comprise an additive selected from: a solubilizer, a surfactant, a non-metal salt, a viscosity modifier, and the like, and combinations thereof. A solubilizer, for example, can be used to increase the solubility of a metal compound and/or a polymer in solution.

Polymers suitable for use with the present invention include, but are not limited to, polyvinylpyrrolidone, a cellulose (e.g., methylcellulose, ethylcellulose, hydroxyethylcellulose, hydroxypropylmethylcellulose, carboxymethylcellulose, and the like), a polyethylene glycol, a polypropylene glycol, a polyacrylic acid, a polyvinylacetate, a polyvinylalcohol, and the like, and combinations thereof.

In some embodiments, a polymer is present in a solution for use with an electrospinning process of the present invention in a concentration of 1% to 15%, 1% to 12%, 1% to 10%, 2% to 15%, 2% to 12%, 2% to 10%, 4% to 15%, 4% to 12%, 4% to 10%, 6% to 15%, 6% to 12%, about 8%, about 10%, or about 12% w/v.

In some embodiments of an electrospinning process, the solution comprising a metal compound and a polymer is flowed at a rate of 0.1 mL/h to 10 mL/h, 0.1 mL/h to 5 mL/h, 0.1 mL/h to 2 mL/h, 0.1 mL/h to 1 mL/h, 0.1 mL/h to 0.5 mL/h, 0.2 mL/h to 5 mL/h, 0.2 mL/h to 2 mL/h, 0.2 mL/h to 1.5 mL/h, 0.2 mL/h to 1 mL/h, 0.3 mL/h to 3 mL/h, 0.3 mL/h to 2 mL/h, 0.3 mL/h to 1.5 mL/h, 0.3 mL/h to 1.2 mL/h, 0.3 mL/h to 1 mL/h, 0.4 mL/h to 1.5 mL/h, about 0.2 mL/h, about 0.3 mL/h, or about 0.4 mL/h.

In some embodiments, an electrospinning process of the present invention comprises flowing a solution that includes a metal compound and a polymer through a biased needle, wherein the needle is about 21 gauge to about 29 gauge, and a bias of about 5 kV to about 50 kV, about 10 kV to about 30 kV, or about 15 kV to about 20 kV is applied to the needle.

In some embodiments, an electrospinning process of the present invention comprises collecting metal compound-polymer nanowires on a biased collector. In some embodiments, the biased collector comprises a metal plate, which is suitable for collecting unaligned nanowires. A collector can also include a pair of metallic (conductive or semiconductive) blades separated by a fixed or variable distance to which a bias is applied, which is suitable for collecting aligned nanowires. In some embodiments, a bias of about 1 kV to about 10 kV, about 2 kV to about 8 kV, about 4 kV to about 6 kV, or about 5 kV is applied to the collector.

In some embodiments, the needle is positively biased and the collector is negatively biased. In some embodiments, the needle is positively biased and the collector is grounded.

In some embodiments, the wires deposited on the biased collector during the electrospinning are heated at a temperature of 100° C. to 1000° C., 100° C. to 800° C., 100° C. to 600° C., 100° C. to 500° C., 100° C. to 400° C., 100° C. to 300° C., or 100° C. to 200° C.

The metal compound-polymer wires are heated at a temperature sufficient and for a time sufficient to convert the metal compound to a metal oxide, wherein the metal oxide wires have an average cross-sectional dimension of 500 μm or less.

Not being bound by any particular theory, in some embodiments the following reaction occurs during the heating:

2M(NO₃)₂→2MO+4NO₂+O₂ (1)

wherein “M” refers to a metal (e.g., Mg, Ca, and the like). Reaction of a metal oxide with water prior to contacting carbon dioxide, can convert at least a portion of a metal oxide to a metal hydroxide as follows:

MO+H₂O→M(OH)₂ (2)

where M is defined above. Formation of a metal hydroxide can occur via contact with ambient humidity, liquid water, and the like.

In some embodiments, the metal-polymer wires are heated for a time of 1 minute to 48 hours, 5 minutes to 36 hours, 10 minutes to 30 hours, 30 minutes to 24 hours, 1 hour to 18 hours, 2 hours to 15 hours, or 3 hours to 12 hours.

In some embodiments, the present invention comprises mechanically converting a metal oxide composition comprising elongated structures to a powder or particulate form. As used herein, a “particulate” refers to a composition comprising distinct three-dimensional shapes having an average width, diameter, and the like, of 1 μm or greater. As used herein, a “powder” refers to a composition comprising distinct three-dimensional shapes having an average width, diameter, and the like, of less than 1 μm.

In some embodiments, a method comprises bonding metal oxide wires or a precursor thereof to provide a monolithic structure. The metal oxide can be bound to a support material using, by way of example only, an adhesive, a covalent bond, an ionic bond, and the like, and combinations thereof.

In some embodiments, metal oxide wires can be at least partially bound to one another in the form of a mat, sheet, membrane, and the like by, before the heating, exposing the metal compound-polymer wires to water vapor. As used herein, “water vapor” refers to a gaseous reagent comprising 50% or more of water. The metal oxide compositions of the present invention can also be bonded to one another and/or to a support or scaffold by processes known in the art such as, but not limited to, sintering, chemical bonding, and the like.

### Methods of Sequestering Carbon Dioxide

The present invention is directed to a method for sequestering carbon dioxide, the method comprising contacting a composition comprising carbon dioxide with a metal oxide composition of the present invention; and reacting the carbon dioxide with at least a portion of the metal oxide composition to form a metal carbonate.

In some embodiments, the contacting and the reacting occur simultaneously. In some embodiments, the contacting and the reacting are distinct from one another. For example, a carbon dioxide molecule may require a specific conformational orientation relative to the metal oxide in order for reaction to occur, or may require thermal and/or chemical activation to initiate the reaction.

The metal oxide compositions of the present invention are more reactive than a bulk form of a metal oxide. In some embodiments, a metal oxide composition of the present invention exhibits an increased reactivity with carbon dioxide of 1.5-fold, two-fold, 2.5-fold, three-fold, four-fold, five-fold, six-fold, eight-fold, nine-fold, or ten-fold or more compared to a bulk metal oxide that does not include the elongated structures of the present invention or products prepared there from (but otherwise having the same chemical composition), wherein reactivity is measured as the time required for reaction to occur at a given temperature.

In some embodiments, reacting a metal oxide composition of the present invention with carbon dioxide occurs at a temperature of 200° C. or lower, 150° C. or lower, 125° C. or lower, 100° C. or lower, 75° C. or lower, 50° C. or lower, 25° C. or lower, 0° C. or lower, −25° C. or lower, −50° C. or lower, or −75° C. or lower.

In some embodiments, the reacting of the metal oxide composition with carbon dioxide is performed at a pressure of 2 atm or lower, 1.75 atm or lower, 1.5 atm or lower, 1.25 atm or lower, 1 atm or lower, 0.75 atm or lower, 0.5 atm or lower, or 0.25 atm or lower.

In some embodiments, the reacting of a metal oxide composition with carbon dioxide is performed at a temperature of 100° C. or lower and a pressure of 1.5 atm or lower. In some embodiments, the reacting of a metal oxide composition with carbon dioxide is performed at a temperature of 25° C. or lower and a pressure of 1 atm or lower. Thus, a metal oxide composition of the present invention is suitable for reacting with carbon dioxide at ambient conditions. Additionally, in some embodiments a metal oxide composition of the present invention is suitable for reacting with carbon dioxide at sub-atmospheric pressure and sub-ambient temperature. Thus, a metal oxide composition of the present invention is suitable for reacting with carbon dioxide present in, for example, the upper atmosphere, a reduced-pressure reactor, and the like.

In some embodiments, a metal oxide composition undergoes a gain in mass of at least 10%, at least 25%, or at least 50% as a result of reacting of the metal oxide composition with carbon dioxide. Not being bound by any particular theory, a metal oxide of the present invention can react with carbon dioxide as follows:

MO+CO₂→MCO₃ (3)

wherein “M” refers to a metal (e.g., Mg, Ca, and the like). Metal hydroxides can also react with carbon dioxide as follows:

M(OH)₂+2CO₂→M(HCO₃)₂ (4)

where M is as defined above.

In some embodiments, a metal oxide and/or metal hydroxide composition of the present invention undergoes reaction with carbon dioxide until substantially all of the metal oxide and/or metal hydroxide is converted to a metal carbonate and/or metal bicarbonate. Substantially complete conversion to a metal carbonate and/or metal bicarbonate can typically occur under reaction conditions in which a stoichiometric excess of carbon dioxide is supplied to the metal oxide and or metal hydroxide composition.

In some embodiments, a composition comprising carbon dioxide is selected from: a gaseous composition, a liquid composition, a solid composition, and combinations thereof. Compositions comprising carbon dioxide can include, but are not limited to, waste, effluent, exhaust, and recirculated air streams.

In some embodiments, before reaction with a metal oxide composition of the present invention, carbon dioxide is present in a composition in a molar concentration of 400 ppm to 99%, by mole, of the composition. In some embodiments, before reaction with a metal oxide composition of the present invention, carbon dioxide is present in a composition in a molar concentration of 1% to 90%, 1% to 50%, 1% to 35%, 1% to 25%, 1% to 15%, 5% to 90%, 5% to 50%, 5% to 25%, 10% to 90%, 10% to 60%, 10% to 30%, 25% to 90%, 25% to 75%, 25% to 50%, 30% to 90%, or 50% to 90% of the composition. For example, the exhaust of a normally running automobile engine contains 13% to 15% carbon dioxide by volume (see, e.g., State of California Dept. of Consumer Affairs Clean Air Car Course Training Manual; Mitchell International: San Diego, Calif. (1993)). However, the increasingly high combustion efficiency of modern automobiles means that the percentage of carbon dioxide on a molar basis can be higher than 15% by volume (see id.).

In some embodiments, a nanostructure of the present invention undergoes a mass increase of 10% or more after 20 minutes or more of exposure to carbon dioxide at a flow rate of 100 cubic feet per hour (cfh). In some embodiments, the nanostructures of the present invention undergo a mass increase upon exposure to carbon dioxide that is at least 100% greater than a percentage increase in mass that a sequestering material having a cross-sectional dimension of 10 μm or more undergoes when exposed to the same carbon dioxide

In some embodiments, by reacting with carbon dioxide to form a metal carbonate, a metal oxide composition of the present invention can sequester 10% or more, 20% or more, 30% or more, 40% or more, 50% or more, 60% or more, or 70% or more, by mole, of the carbon dioxide present in a composition. In particular, the metal oxide compositions and methods of using the same are particularly useful for removing carbon dioxide from an automobile exhaust composition, a truck exhaust composition, a power plant exhaust composition, a jet exhaust composition, and the like.

The metal oxide compositions and methods of using the same are also useful for removing carbon dioxide from recirculating air systems, and in particular recirculating air systems used in underwater applications. In some embodiments, the metal oxide compositions and methods of using the same are used in a rebreather apparatus (e.g., a closed circuit breathing apparatus, a semi-closed circuit breathing apparatus), in breathing apparatus for mine rescue, personal protective equipment, and other industrial environments where poisonous gases can be present or oxygen levels can be lower than ambient, in crewed spacecraft and space suits in hospital anesthesia breathing systems (e.g., to supply a controlled dose of anesthetic to a patient without exposing staff to the dose), in submarines and hyperbaric oxygen therapy chambers, and the like.

The process products of the reaction between a metal oxide composition and carbon dioxide are metal carbonates. In some embodiments, a metal carbonate provided as a result of reacting carbon dioxide with a metal oxide composition of the present invention is selected from MgO, CaO, and combinations thereof (e.g., dolomite). The metal carbonates are advantageous because these compounds are non-toxic and robust. As used herein, “robust” refers to physical, dimensional and/or chemical stability. For example, the metal carbonate products of the present invention exhibit chemical stability that makes them suitable for sequestering carbon in a wide range of environments. Thus, the products of the present invention are robust and stable for an extended period of time.

Having generally described the invention, a further understanding can be obtained by reference to the examples provided herein. These examples are given for purposes of illustration only and are not intended to be limiting.

### EXAMPLES

### Example 1

Elongated structures comprising a metal compound (magnesium nitrate) and a polymer (polyvinylpyrrolidone) were electrospun by the following procedure. Solutions of magnesium nitrate hexahydrate (450 mg) in deionized water (1.5 mL) and polyvinylpyrrolidone (450 mg) in ethanol (3.8 mL) were vortex mixed until a clear precursor solution resulted. The precursor solution was flowed at a rate of about 0.1 mL/hr/spinneret to about 0.5 mL/hr/spinneret through a 23 gauge stainless steel needle (a 21-29 gauge needle is suitable) to which was applied a DC voltage of about 10 kV to about 30 kV. The flow rate of the precursor solution was controlled using a syringe pump. A collector comprising an aluminum plate that was either grounded or negatively biased with a DC voltage of about 5 kV) was placed about 150 mm from the needle tip. Non-woven mats of composite Mg(NO₃)₂-PVP wires were collected on the grounded metal plate when the precursor solution was flowed. The electrospinning and collecting was performed in a humidity-controlled environment having a relative humidity of about 40% or less.

The Mg(NO₃)₂-PVP wires were transferred from the collector to a furnace pre-heated to 200° C. Exposure of the Mg(NO₃)₂-PVP wires to the ambient atmosphere was minimized during the transfer. The furnace was then ramped to 500° C. at a rate of about 2° C. to about 10° C. per minute, and then the furnace temperature was held at 500° C. for 1 hour. The furnace temperature was then decreased to about 250° C., the wires were removed from the furnace and cooled to ambient temperature in a nitrogen-purged container and then placed on a balance to measure the mass of the wires.

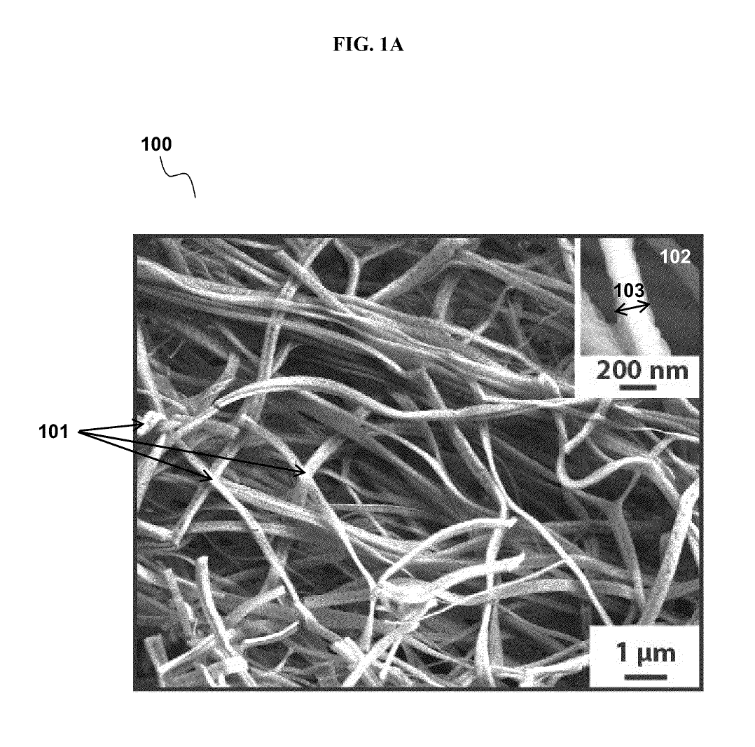

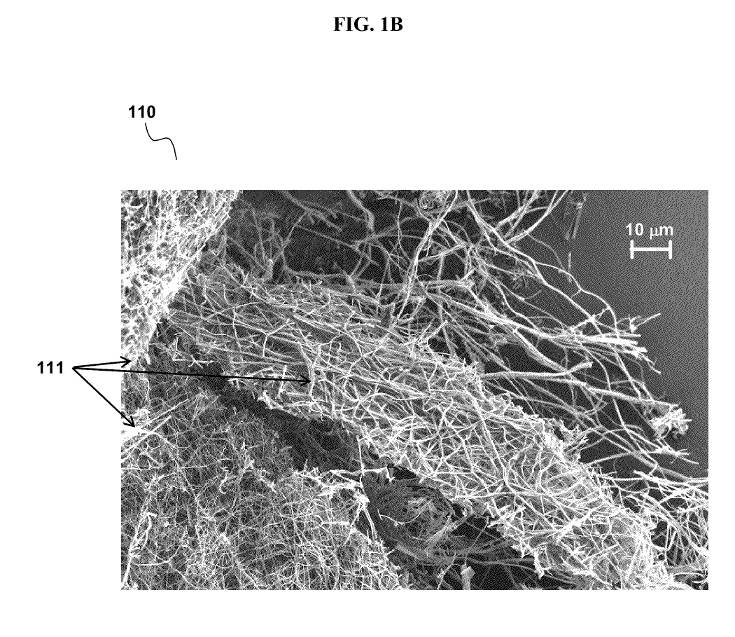

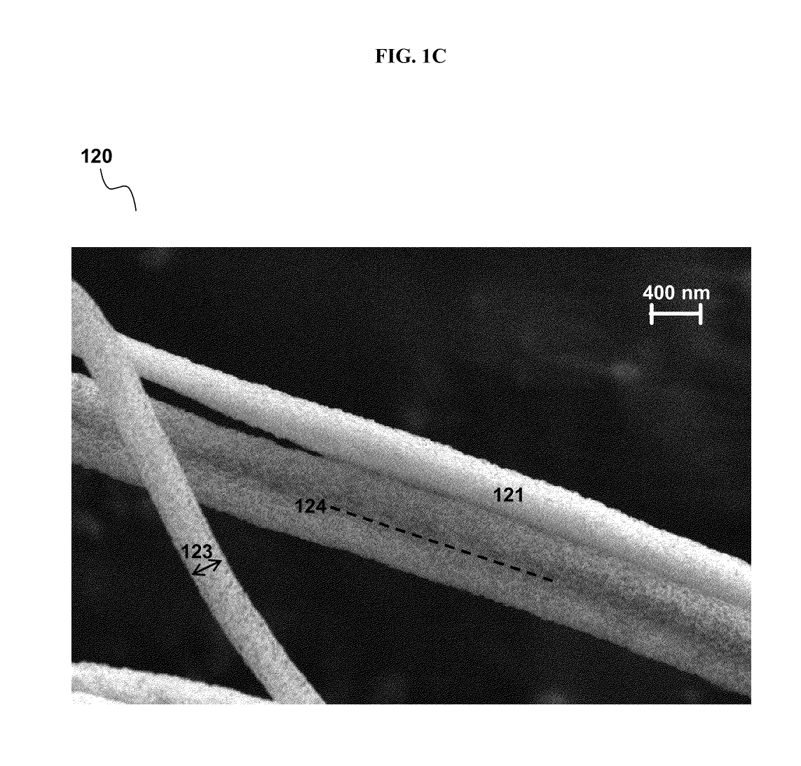

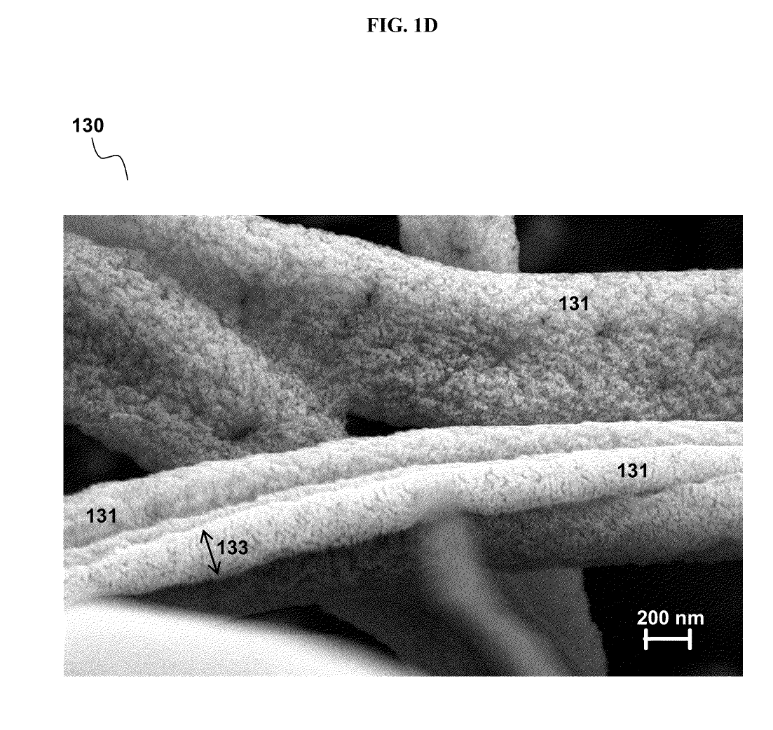

FIG. 1A provides a scanning electron microscope (“SEM”) image, 100, of a plurality of elongated metal oxide structures, 101, prepared by the process of Example 1. The elongated metal oxide structures, 101, are composed primarily of magnesium oxide (MgO). As shown in the inset, 102, the elongated metal oxide structures have an average cross-sectional dimension, 103, of about 150 nm to about 200 nm.

FIG. 1B provides a SEM image, 110, of a non-woven mat, 111, comprising elongated MgO structures of the present invention.

FIG. 1C provides a SEM image, 120, of an elongated metal oxide (MgO) structure of the present invention, 121. The metal oxide structure has a cross-sectional dimension, 123, of about 300 nm. In some embodiments, at least a portion of the elongated structures are bonded or fused to one another, 124.

FIG. 1D provides a SEM image, 130, of an elongated metal oxide (MgO) structure of the present invention, 131. The metal oxide structure has a cross-sectional dimension, 133, of about 250 nm. In some embodiments, at least a portion of the elongated structures are bonded or fused to one another, 134.

### Example 2

MgO wires were prepared as in Example 1, except that before the Mg(NO₃)₂-PVP wires were placed in the furnace, the Mg(NO₃)₂-PVP wires were exposed to humid air (having a relative humidity of about 70% to about 85%) for a period of about 10 minutes. As a result of the exposure to humid air, the metal oxide composition was a mat composed of fused MgO wires.

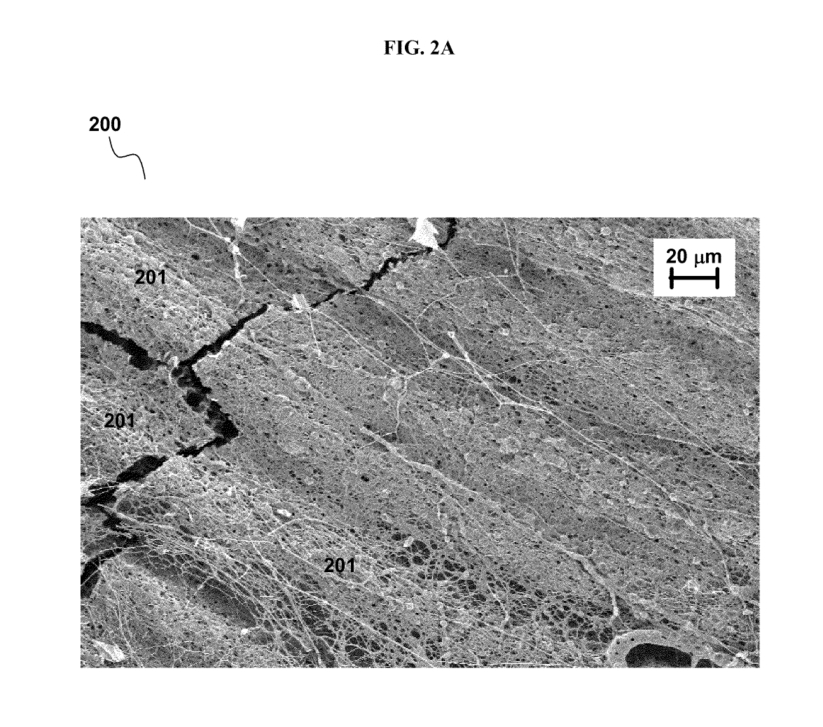

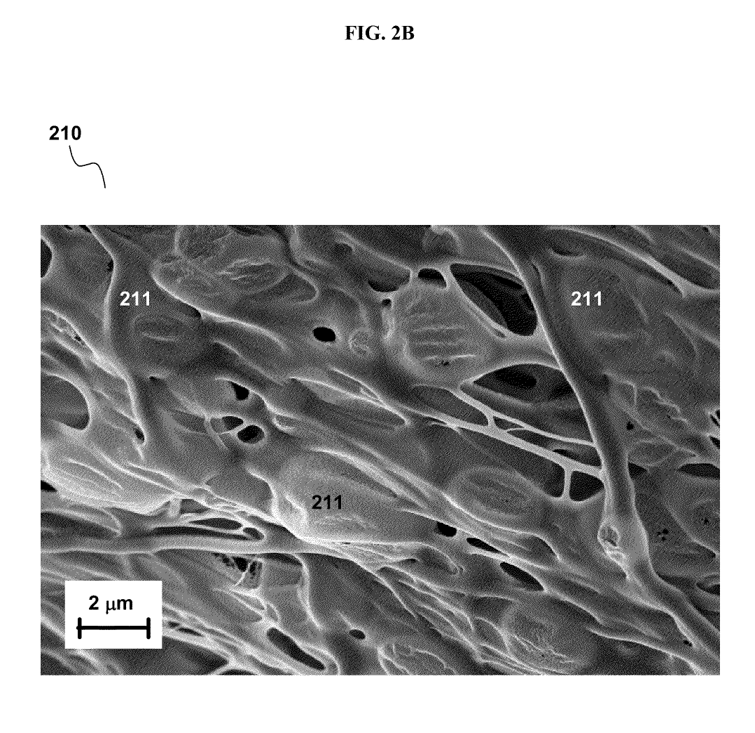

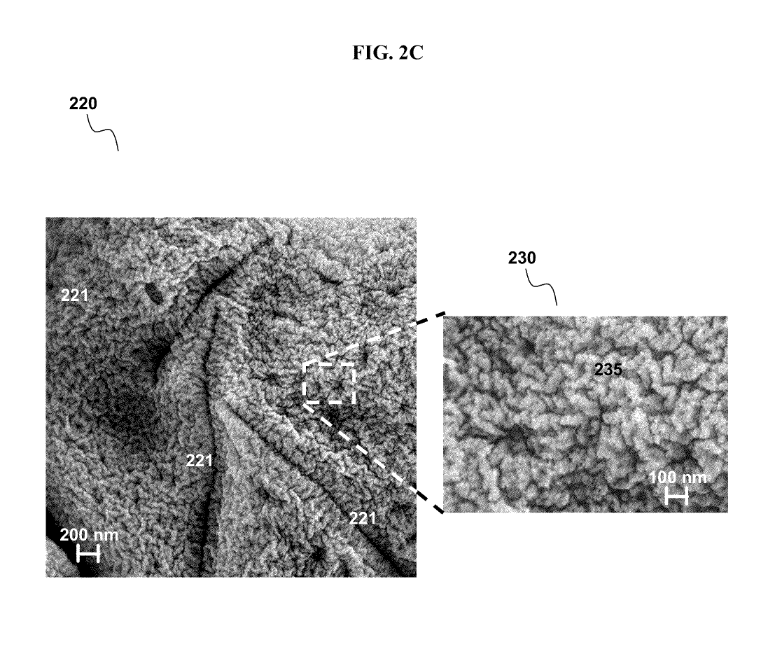

FIG. 2A provides a SEM image, 200, of a plurality of elongated metal oxide structures that are bonded to one another in a mat structure, 201, prepared by the process of Example 3. The elongated metal oxide structures, 201, are composed primarily of magnesium oxide (MgO).

FIG. 2B provides a SEM image, 210, of a mat, 211, comprising elongated MgO structures of the present invention that were chemically fused to one another prior to calcining, as described in the process of Example 3.

FIG. 2C provides a close-up SEM image, 220, of a mat, 221, comprising bonded or fused MgO wires, as prepared by a second process according to the method of Example 3. Referring to inset, 230, the MgO present in the mat has a grain structure, 235, with a grain size of about 10 nm or less.

### Example 3

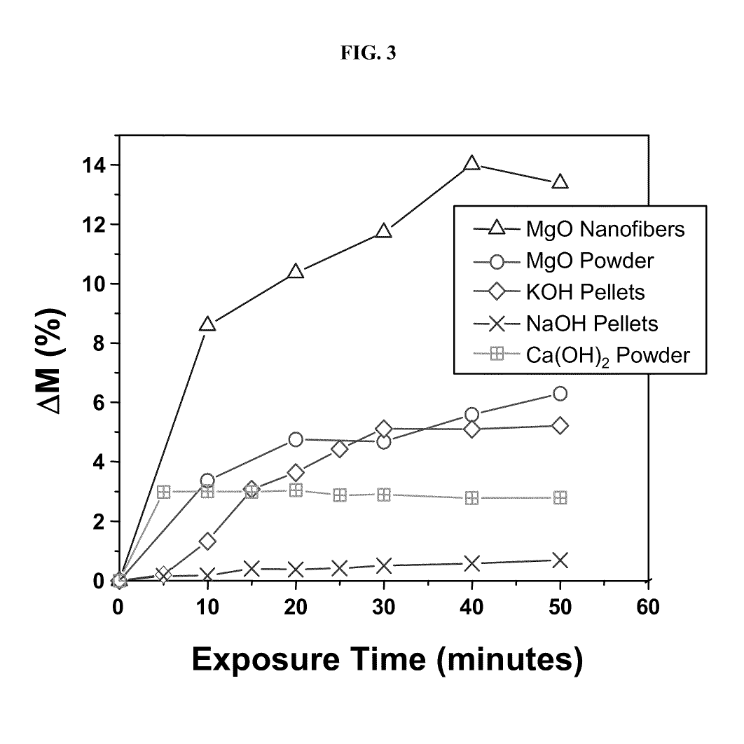

MgO wires prepared as in Example 1 were reacted with CO₂ under the following conditions. The MgO wires (approximately 1 g of material) were placed in a flow cell (1 cm diameter×4 cm length) made from polypropylene tubing. A small plug of polypropylene microfiber was placed on each side of the MgO wires to prevent movement of the MgO wires under flow conditions. The MgO wires were then exposed to CO₂ at a flow rate of 10 cubic feet per hour (cfh). The mass of the MgO wires was measured before and addition to the flow cell, and the mass of the flow cell with the MgO wires inside was monitored as a function of exposure time. The mass of the flow cell and wires was measured periodically by stopping the gas flow, unhooking connections from the inlet and outlet ends of the flow cell, and measuring the mass of the cell and wires. The percentage increase in the mass (ΔM %) of the MgO wires as a function of exposure time is shown graphically in FIG. 3.

Additional materials (MgO powder, KOH pellets, NaOH pellets, and Ca(OH)₂ powder) were also tested using the same method. The results are also provided graphically in FIG. 3.

Referring to FIG. 3, the MgO wires absorbed 100% more CO₂ than the next best materials (the MgO powder and KOH pellets), and absorbed 500% more CO₂ than the Ca(OH)₂ powder.

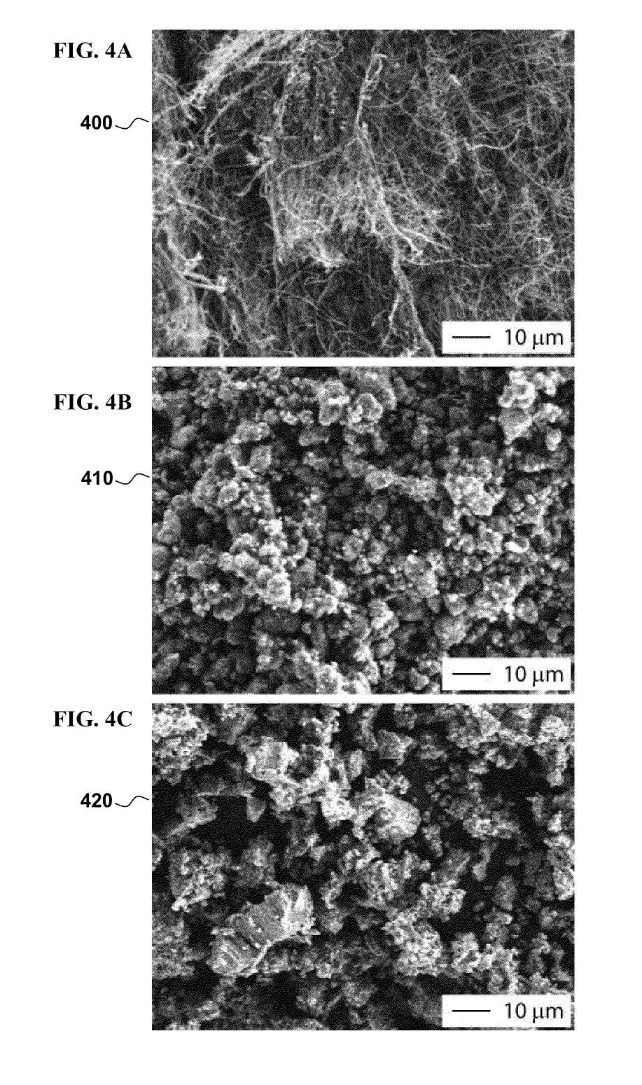

FIGS. 4A-4C provide SEM images, 400, 410, and 420, respectively, of the MgO wires, the MgO powder, and the Ca(OH)₂ powder prior to contact with CO₂. Referring to FIG. 4A, the MgO wires have an average cross-sectional dimension, 401, of about 200 nm to about 400 nm.

Referring to FIG. 4B, the MgO powder has an average cross-sectional dimension, 411, of about 4 μm to about 8 μm.

Referring to FIG. 4C, the Ca(OH)₂ powder has an average cross-sectional dimension, 421, of about 2 μm to about 4 μm.

Thus, the cross-sectional dimension of the MgO wires is at least an order of magnitude less than that of the MgO or Ca(OH)₂ powders. Not being bound by any particular theory, the improved performance of the MgO wires correlates with the lower cross-sectional dimensions of this material and the commensurate increased surface area.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method for sequestering carbon dioxide, the method comprising:
contacting a composition comprising carbon dioxide with a metal oxide composition, wherein the metal oxide composition has an average cross-sectional dimension of 500 μm or less, and wherein the metal oxide composition has an average metal oxide grain size of 50 nm or less; and
reacting the carbon dioxide with at least a portion of the metal oxide composition to form a metal carbonate.

2. The method of claim 1, wherein the metal oxide composition has an average cross-sectional dimension of 10 nm to 100 μm.

3. The method of claim 1, wherein the metal oxide composition comprises a plurality of elongated structures having an average length of 1 cm or more.

4. The method of claim 1, wherein the metal oxide is selected from: MgO, Mg(OH)₂, Mg₂SiO₄, Mg₃Si₂O₅(OH)₄, Na₂O, K₂O, CaO, Ca(OH)₂, FeO, Fe₂O₃, and combinations thereof.

5. The method of claim 1, wherein the metal oxide composition comprises a plurality of elongated structures as a non-woven mat.

6. The method of claim 1, wherein the metal oxide composition has a surface area of 5 m²/g or greater.

7. The method of claim 1, wherein the metal oxide composition has a surface area of 15 m²/cm³ or greater.

8. The method of claim 1, wherein the reacting is performed at a temperature of 200° C. or lower.

9. The method of claim 1, wherein the reacting is performed at a pressure of 2 atm or lower.

10. The method of claim 1, wherein the reacting is performed at a temperature of 100° C. or lower and a pressure of 1.5 atm or lower.

11. The method of claim 1, wherein the metal oxide composition undergoes a gain in mass of at least 10% as a result of the reacting.

12. The method of claim 1, wherein the reacting reduces the molar concentration of carbon dioxide in the composition by 10% or greater.

13. The method of claim 1, wherein the metal oxide composition comprises a metal hydroxide.

14. The method of claim 13, comprising contacting a composition comprising carbon dioxide with the metal hydroxide; and reacting the carbon dioxide with at least a portion of the metal hydroxide to form a metal bicarbonate.

15. A composition comprising a metal oxide selected from: MgO, Mg(OH)₂, Mg₂SiO₄, Mg₃Si₂O₅(OH)₄, Na₂O, K₂O, CaO, Ca(OH)₂, FeO, Fe₂O₃, and combinations thereof, wherein the metal oxide is present as a plurality of elongated structures having an average cross-sectional dimension 500 μm or less, wherein the plurality of elongated structures has an average metal oxide grain size of 50 nm or less, and wherein the metal oxide has a surface area of 5 m²/g or greater.

16. The composition of claim 15, wherein the plurality of elongated structures have an average cross-sectional dimension 10 nm to 100 μm.

17. The composition of claim 15, wherein the plurality of elongated structures have an average length of 1 cm or more.

18. The composition of claim 15, wherein the metal oxide composition has a surface area of 50 m²/cm³ or greater.

19. The composition of claim 15, wherein the metal oxide composition has an average interstitial porosity of 20% or greater.

20. The of claim 16, wherein the metal oxide composition has an average interstitial pore size of 10 nm to 10 μm.

21. An article of manufacture comprising the metal oxide composition of claim 15.

22. The article of manufacture of claim 19, wherein the metal oxide composition is present as a non-woven mat.

23. The article of manufacture of claim 19, wherein the article of manufacture is a flow-through device and the metal oxide composition is present as a packing material.

24. A method of making a metal oxide composition, the method comprising:
(a) electrospinning a plurality of metal compound-polymer wires by:
(i) flowing a solution comprising a metal compound and a polymer through a biased needle to provide a plurality of metal compound-polymer wires; and
(ii) collecting the metal compound-polymer wires with a biased collector; and
(b) heating the metal compound-polymer wires in an oxidizing atmosphere at a temperature sufficient and for a time sufficient to convert the metal compound to a metal oxide, wherein the metal oxide wires have an average cross-sectional dimension of 10 nm to 10 μm.

25. The method of claim 24, wherein the metal compound is selected from: Mg(NO₃)₂, Ca(NO₃)₂, Mg(CH₃CO₂)₂, Ca(CH₃CO₂)₂, CaCl₂, MgCl₂, Na(CH₃CO₂), K(CH₃CO₂), hydrates thereof, and combinations thereof.

26. The method of claim 24, wherein the metal oxide is selected from: MgO, Mg(OH)₂, Mg₂SiO₄, Mg₃Si₂O₅(OH)₄, Na₂O, K₂O, CaO, Ca(OH)₂, FeO, Fe₂O₃, and combinations thereof.

27. The method of claim 24, wherein the heating comprises a temperature of 100° C. to 1000° C.

28. The method of claim 24, wherein the heating comprises a time of 1 minute to 48 hours.

29. The method of claim 24, comprising mechanically converting the metal oxide wires to a powder or particulate form.

30. The method of claim 24, comprising bonding the metal oxide wires or a precursor thereof to provide a monolithic structure.

31. The method of claim 24, comprising exposing either of the metal compound-polymer wires or the metal oxide composition to water vapor.

32. The method of claim 24, comprising affixing the metal oxide composition to a support material.

33. A product prepared by the method of claim 24.
